(19) United States
(12) Patent Application Publication
(10) Pub. No.: US 2009/0093315 A1
(43) Pub. Date: Apr. 9, 2009

(54) Storage medium storing load detection program, load detection apparatus, and load detection method

(75) Inventors: Hiroshi Matsunaga, Kyoto (JP); Tadashi Sugiyama, Kyoto (JP); Yuji Sawatani, Kyoto (JP)

Correspondence Address: NIXON & VANDERHYE, PC, 901 NORTH GLEBE ROAD, 11TH FLOOR, ARLINGTON, VA, 22203, US

(73) Assignee: NINTENDO CO., LTD., Kyoto (JP)

(21) Appl. No.: 12/216,828

(22) Filed: Jul. 11, 2008

(30) Foreign Application Priority Data
Oct. 4, 2007 (JP) 2007-260820

(51) Int. Cl. G06F 17/00; A63F 9/24

(52) U.S. Cl. 463/43; 463/36

(57) ABSTRACT

A game system includes a game apparatus. To the game apparatus are connected a monitor, a controller, and a load controller. When the game apparatus starts a game, prior to starting the main content, a weight value of a player is detected and the weight value is set as a reference value. When the reference value is already set, the detected weight value of the player is compared with the reference value. When a comparison result shows a match, the game apparatus continues game play. On the other hand, when the comparison result shows a mismatch, the game apparatus confirms the player whether to continue the game and when the game is continued, the weight value of the player detected this time is reset as the reference value.

### CROSS REFERENCE OF RELATED APPLICATION

The disclosure of Japanese Patent Application No. 2007-260820 is incorporated herein by reference.

### BACKGROUND OF THE INVENTION

1. Field of the Invention

The present invention relates to a storage medium storing a load detection program, a load detection apparatus, and a load detection method and more particularly, for example, to a storage medium storing a load detection program, a load detection apparatus, and a load detection method for performing information processing for a game, etc., using a weight value of a user.

2. Description of the Related Art

Conventionally, there has been known an apparatus that performs information processing for a game, etc., using a measured weight value of a player. An example of this type of the related art is disclosed in Japanese Patent Laying-open No. 2000-146679 [G01G 19/44, A63F 13/00, G01G 19/52] laid-open on May 26, 2000. This related art discloses that a game proceeds based on input information including a measured weight value of a user. Specifically, by the user getting on a weight measuring unit including a load cell, etc., a measured value according to a weight is outputted and stored in a RAM. For example, a measured weight value of the user is registered in the RAM once a day and according to an increase and decrease from an average value of measured weight values registered in the past, game content is changed.

In this related art, however, a game proceeds according to a change in user's weight and thus there is a problem that it is not possible to judge whether a user is changed to another user in the middle of the game. For example, in the case of continuously playing a game, when the same user continuously plays, there is no problem in performing game processing based on measured weight values stored in the RAM; however, if a user is changed to another user in midstream, a problem may occur that since the measured weight values stored in the RAM are different from an actual weight value of another user, game processing after the change is not properly performed.

### SUMMARY OF THE INVENTION

Therefore, it is a principal object of the present invention to provide a storage medium storing a novel load detection program, a novel load detection apparatus, and a novel load detection method.

It is another object of the present invention to provide a storage medium storing a load detection program, a load detection apparatus, and a load detection method that are capable of setting a proper weight value as a reference value even when a player is changed to another player.

To solve the above-described problems, the present invention adopts the following configurations. It is to be understood that reference numerals, supplemental remarks, and the like, in parentheses illustrate the corresponding relationship with embodiments, as will be described later, to assist in the understanding of the present invention, and thus are not intended to limit the present invention in any way.

A first invention is directed to a load detection program to be executed by a computer of a load detection apparatus that includes a supporting board on which feet of a user can be put. The load detection program causes the computer to perform an instruction step, a load value detection step, a reference value setting step, an information processing step, a judgment timing determination step, a comparison step, and a reference value update step. In the instruction step, an instruction is provided to put the feet of the user on the supporting board. In the load value detection step, a load value imposed on the supporting board is detected. In the reference value setting step, the load value detected in the load value detection step is set as a reference value of a weight value of the user. In the information processing step, information processing is performed based on the reference value set in the reference value setting step and a load value to be detected in the load value detection step. In the judgment timing determination step, it is determined whether or not it is timing at which the reference value is to be judged. In the comparison step, when it is determined in the judgment timing determination step that it is timing at which the reference value is to be judged, the reference value set in the reference value setting step is compared with the load value detected in the load value detection step. Then, in the reference value update step, when a comparison result obtained in the comparison step shows a mismatch, the load value detected in the load value detection step is reset as the reference value.

In the first invention, a load detection program is executed by a computer (40, 42) of a load detection apparatus (12, 36) including a supporting board (36a) on which the feet of a user can be put. In an instruction step (40, S5, S37), an instruction is provided to put the feet of the user on the supporting board. In a load value detection step (40, S7, S39), a load value imposed on the supporting board is detected. That is, a weight value of the user is detected. In a reference value setting step (40, S11), the load value detected in the load value detection step is set as a reference value of the weight value of the user. In an information processing step (40, S23), information processing is performed based on the reference value set in the reference value setting step and a load value to be detected in the load value detection step. For example, information processing is performed using a difference between the reference value and the load value as an input. In a judgment timing determination step (40, S3, S35), it is determined whether or not it is timing at which the reference value is to be judged. In a comparison step (40, S13, S41), when it is determined in the judgment timing determination step that it is timing at which the reference value is to be judged, the reference value set in the reference value setting step is compared with the load value detected in the load value detection step. Then, in a reference value update step (40, S21, S49), when a comparison result obtained in the comparison step shows a mismatch, i.e., when it is considered that a user is changed to another user, the load value detected in the load value detection step is reset as the reference value. That is, the weight value of the user after the change is set as the reference value.

According to the first invention, when a user is changed to another user, a weight value of the user after the change is set as a reference value, and thus, even when a user is changed to another user in midstream, information processing can be performed with a proper reference value.

A second invention depends from the first invention and in the comparison step, a difference between the reference value set in the reference value setting step and a load value to be detected in the load value detection step is detected and when the difference exceeds a predetermined value, a comparison result shows a mismatch.

In the second invention, in the comparison step, when a difference between a reference value and a load value exceeds a predetermined value, a comparison result shows a mismatch. That is, when a difference between weight values exceeds a certain range, it is determined that a different user is on the board. This is because if it is strictly determined as to whether the values match, even when a load value (weight value) is slightly changed because of the posture of the user, it is mistakenly determined that a user is changed to a different user.

According to the second invention, it is possible to properly determine whether or not a user is changed to another user. Therefore, information processing can be performed with a proper reference value.

A third invention depends from the first invention or the second invention and the load detection program further causes the computer to perform an instruction determination step of determining whether or not there is an instruction from the user to perform the information processing, and in the judgment timing determination step, when it is determined in the instruction determination step that there is an instruction to perform the information processing, it is determined that it is judgment timing of the reference value.

In the third invention, in an instruction determination step (40, S3), it is determined whether or not there is an instruction from the user to perform information processing. For example, it is determined whether or not there is a game processing start instruction. As such, when there is an instruction to perform information processing such as a game processing start instruction, it is considered that there is a possibility of a user being changed to another user, and thus, it is determined that it is judgment timing of the reference value.

According to the third invention, it is possible to determine at an appropriate time whether or not a user is changed to another user.

A fourth invention depends from any of the first to the third inventions and the load detection program further causes the computer to perform a load value determination step of determining whether or not, during performance of the information processing, a period of time during which a load value to be detected in the load value detection step is less than or equal to a predetermined value is maintained over a certain period of time, and in the judgment timing determination step, when it is determined in the load value determination step that a period of time during which the load value is less than or equal to the predetermined value is maintained over a certain period of time, it is determined that it is timing at which the reference value is to be judged.

In the fourth invention, in a load value determination step (40, S31, S33, S35), it is determined whether or not, during performance of information processing, a period of time during which a load value is less than or equal to a predetermined value is maintained over a certain period of time. When a period of time during which the load value is less than or equal to the predetermined value is maintained over a certain period of time, i.e., when a state in which no user is on the supporting board continues over a certain period of time, there is a possibility that a user may be changed to another user, and thus, it is determined that it is timing at which the reference value is to be judged.

In the fourth invention too, it is possible to determine at an appropriate time whether or not a user is changed to another user.

A fifth invention is directed to a load detection apparatus including a supporting board on which feet of a user can be put. The apparatus comprises an instruction means, a load value detection means, a reference value setting means, an information processing means, a judgment timing determination means, a comparison means, and a reference value update means. The instruction means instructs to put the feet of the user on the supporting board. The load value detection means detects a load value imposed on the supporting board. The reference value setting means sets the load value detected by the load value detection means, as a reference value of a weight value of the user. The information processing means performs information processing based on the reference value set by the reference value setting means and a load value to be detected by the load value detection means. The judgment timing determination means determines whether or not it is timing at which the reference value is to be judged. The comparison means compares, when it is determined by the judgment timing determination means that it is timing at which the reference value is to be judged, the reference value set by the reference value setting means with the load value detected by the load value detection means. The reference value update means resets, when a comparison result obtained by the comparison means shows a mismatch, the load value detected by the load value detection means as the reference value.

In the fifth invention too, as with the first invention, even when a user is changed to another user in midstream, information processing can be performed with a proper reference value.

A sixth invention is directed to a load detection method for a load detection apparatus including a supporting board on which feet of a user can be put. The method includes the steps of: (a) instructing to put the feet of the user on the supporting board; (b) detecting a load value imposed on the supporting board; (c) setting the load value detected in the step (b) as a reference value of a weight value of the user; (d) performing information processing based on the reference value set in the step (c) and a load value to be detected in the step (b); (e) determining whether or not it is timing at which the reference value is to be judged; (f) comparing, when it is determined in the step (e) that it is timing at which the reference value is to be judged, the reference value set in the step (c) with the load value detected in the step (b); and (g) resetting, when a comparison result obtained in the step (f) shows a mismatch, the load value detected in the step (b) as the reference value.

In the sixth invention too, as with the first invention, even when a user is changed to another user in midstream, information processing can be performed with a proper reference value.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an illustrative view showing one embodiment of a game system of the present invention;

FIG. 2 is a block diagram showing an electrical configuration of the game system shown in FIG. 1;

FIG. 3 is an illustrative view for describing an external appearance of a controller shown in FIG. 1;

FIG. 4 is a block diagram showing an electrical configuration of the controller shown in FIG. 3;

FIG. 5 is an illustrative view for describing an external appearance of a load controller shown in FIG. 1;

FIG. 6 is a cross-sectional view of the load controller shown in FIG. 5;

FIG. 7 is a bock diagram showing an electrical configuration of the load controller shown in FIG. 5;

FIG. 8 is an illustrative view for generally describing a state for when a game is played using the controller and the load controller shown in FIG. 1;

FIG. 9 is an illustrative view for describing viewing angles of markers and the controller shown in FIG. 1;

FIG. 10 is an illustrative view showing an example of an imaged image containing target images;

FIG. 11 is an illustrative view showing examples of screens to be displayed on a monitor shown in FIG. 1;

FIG. 12 is an illustrative view showing an example of a memory map of a main memory of the game apparatus shown in FIG. 2;

FIG. 13 is a flowchart showing part of an overall process of a CPU shown in FIG. 2;

FIG. 14 is a flowchart showing the other part of the overall process of the CPU shown in FIG. 2 and continued from FIG. 13;

FIG. 15 is a flowchart showing part of an overall process of a CPU in a second embodiment;

FIG. 16 is an illustrative view showing an example of a data memory area provided in a main memory of a game apparatus in a third embodiment;

FIG. 17 is a flowchart showing part of an overall process of a CPU in the third embodiment; and

FIG. 18 is an illustrative view showing another example of a screen to be displayed on the monitor shown in FIG. 1.

### DETAILED DESCRIPTION OF THE PREFERRED EMBODIMENTS

### First Embodiment

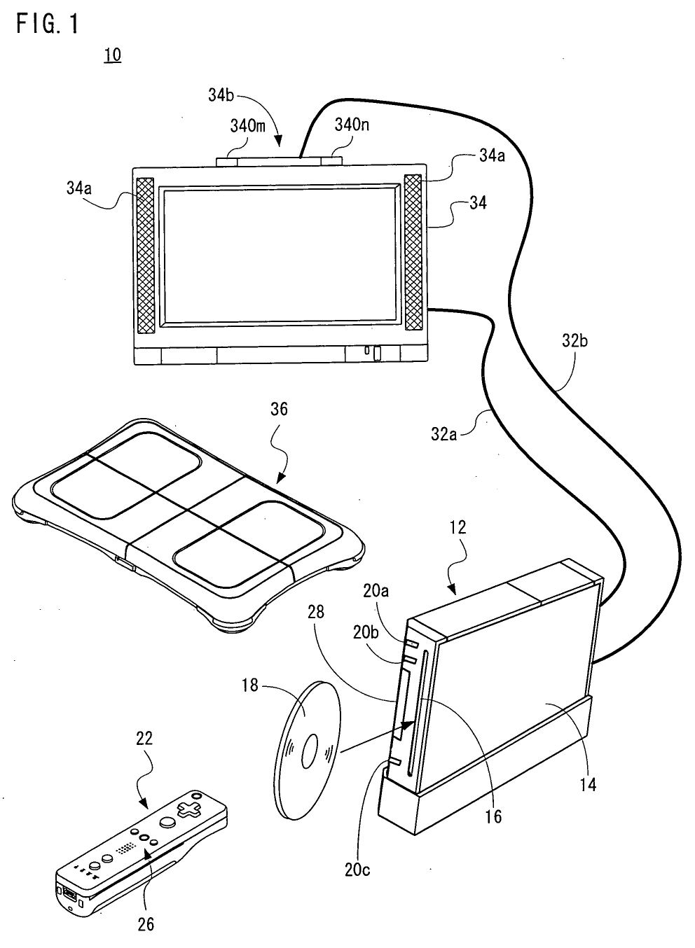

Referring to FIG. 1, a game system 10 of one embodiment of the present invention includes a video game apparatus (hereinafter referred to as “game apparatus”) 12, a controller 22 and a load controller 36. In this embodiment, the game apparatus 12 and the load controller 36 function as a load detection apparatus. Additionally, although illustration is omitted, in this embodiment, the game apparatus 12 is designed so as to be communicably connectable with a maximum of four controllers (22, 36). Also, the game apparatus 12 and each of the controllers (22, 36) are connected by radio. For example, wireless communication is executed according to Bluetooth (registered trademark) standard, and may be executed by other standards, such as infrared rays and wireless LAN. Alternatively, they may be connected by a wire.

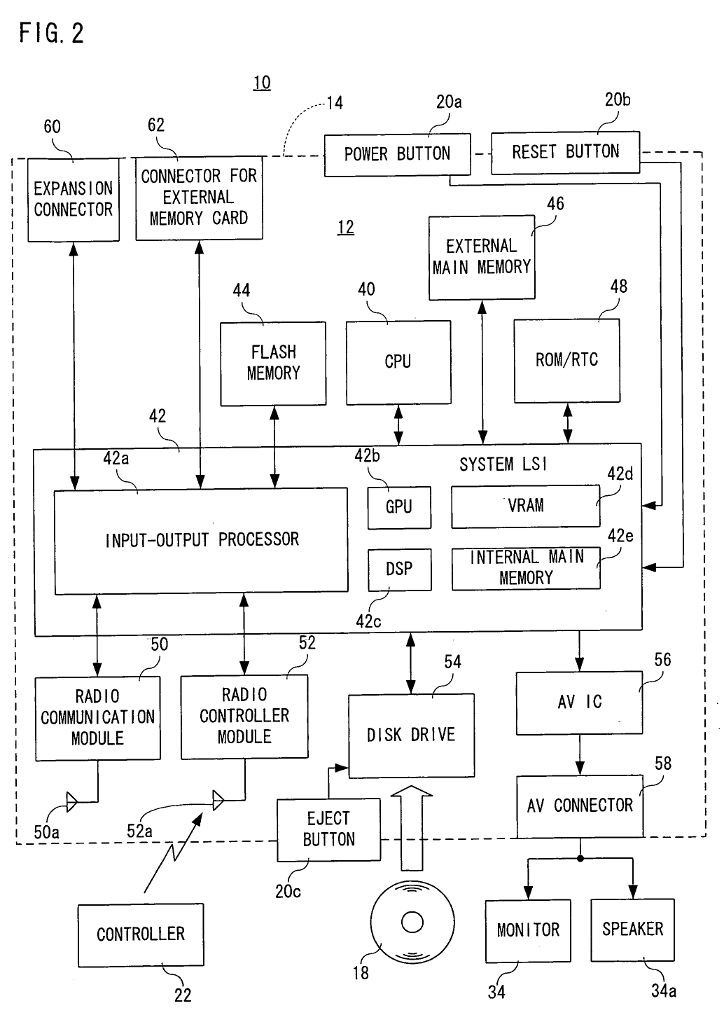

The game apparatus 12 includes a roughly rectangular parallelepiped housing 14, and the housing 14 is provided with a disk slot 16 on a front surface. An optical disk 18 as one example of an information storage medium storing game program, etc. is inserted into the disk slot 16 to be loaded in a disk drive 54 (see FIG. 2) within the housing 14. Around the disk slot 16, an LED and a light guide plate are arranged so as to be turned on in response to various processing.

Furthermore, on a front surface of the housing 14 of the game apparatus 12, a power button 20a and a reset button 20b are provided at the upper part thereof, and an eject button 20c is provided below them. In addition, a connector cover for external memory card 28 is provided between the reset button 20b and the eject button 20c, and in the vicinity of the disk slot 16. Inside the connector cover for external memory card 28, an external connector for memory card 62 (see FIG. 2) is provided, through which an external memory card (hereinafter simply referred to as a “memory card”) not shown is inserted. The memory card is employed for loading the game program, etc. read from the optical disk 18 to temporarily store it, storing (saving) game data (result data or proceeding data of the game) of the game played by means of the game system 10, and so forth. It should be noted that storing the game data described above may be performed on an internal memory, such as a flash memory 44 (see FIG. 2) inside the game apparatus 12 in place of the memory card. Also, the memory card may be utilized as a backup memory of the internal memory.

It should be noted that as a memory card, a general-purpose SD card can be employed, but other general-purpose memory cards, such as memory sticks, multimedia cards (registered trademark) can be employed.

The game apparatus 12 has an AV cable connector 58 (FIG. 2) on the rear surface of the housing 14, and by utilizing the AV cable connector 58, a monitor 34 and a speaker 34a are connected to the game apparatus 12 through an AV cable 32a. The monitor 34 and the speaker 34a typically are a color television receiver, and through the AV cable 32a, a video signal from the game apparatus 12 is input to a video input terminal of the color television, and a sound signal is input to a sound input terminal. Accordingly, a game image of a three-dimensional (3D) video game, for example, is displayed on the screen of the color television (monitor) 34, and stereo game sound, such as a game music, a sound effect, etc. is output from right and left speakers 34a. Around the monitor 34 (on the top side of the monitor 34, in this embodiment), a marker unit 34b including two infrared ray LEDs (markers) 34m and 34n is provided. The marker unit 34b is connected to the game apparatus 12 through a power source cable 32b. Accordingly, the marker unit 34b is supplied with power from the game apparatus 12. Thus, the markers 34m and 34n emit lights in front of the monitor 34.

Furthermore, the power of the game apparatus 12 is applied by means of a general AC adapter (not illustrated). The AC adapter is inserted into a standard wall socket for home use, and the game apparatus 12 transforms the house current (commercial power supply) to a low DC voltage signal suitable for driving. In another embodiment, a battery may be utilized as a power supply.

In the game system 10, a user or a player turns the power of the game apparatus 12 on for playing the game (or applications other than the game). Then, the user selects an appropriate optical disk 18 storing a program of a video game (or other applications the player wants to play), and loads the optical disk 18 into the disk drive 54 of the game apparatus 12. In response thereto, the game apparatus 12 starts to execute a video game or other applications on the basis of the program recorded in the optical disk 18. The user operates the controller 22 in order to apply an input to the game apparatus 12. For example, by operating any one of the input means 26, a game or other application is started. Besides the operation with respect to the input means 26, by moving the controller 22 itself, it is possible to move a moving image object (player object) in different directions or change the perspective of the user (camera position) in a 3-dimensional game world.

FIG. 2 is a block diagram of an electric configuration of the video game system 10 in FIG. 1 embodiment. Although illustration is omitted, the respective components within the housing 14 are contained on a printed board. As shown in FIG. 2, the game apparatus 12 has a CPU 40. The CPU 40 functions as a game processor. The CPU 40 is connected to a system LSI 42. The system LSI 42 is connected with an external main memory 46, a ROM/RTC 48, a disk drive 54, and an AV IC 56.

The external main memory 46 stores programs like a game program, etc., stores various data, and is utilized as a work area and a buffer area of the CPU 40. The ROM/RTC 48, the so-called boot ROM, is incorporated with a program for activating the game apparatus 12, and provided with a time circuit for counting a time. The disk drive 54 reads program data, texture data, etc. from the optical disk 18, and writes it in an internal main memory 42e described later or the external main memory 46 under the control of the CPU 40.

The system LSI 42 is provided with an input-output processor 42a, a GPU (Graphics Processor Unit) 42b, a DSP (Digital Signal Processor) 42c, a VRAM 42d and an internal main memory 42e, and these are connected with each other by internal buses although illustration is omitted.

The input-output processor (I/O processor) 42a executes transmission and reception of data, downloads of data, and so forth. A detailed description is made later as to transmission and reception and download of the data.

The GPU 42b is made up of a part of a rendering means, and receives a graphics command (construction command) from the CPU 40 to generate game image data according to the command. Additionally, the CPU 40 applies an image generating program required for generating game image data to the GPU 42b in addition to the graphics command.

Although illustration is omitted, the GPU 42b is connected with the VRAM 42d as described above. The GPU 42b accesses the VRAM 42d to acquire the data (image data: data such as polygon data, texture data, etc.) required to execute the construction command. Additionally, the CPU 40 writes the image data required for drawing to the VRAM 42d via the GPU 42b. The GPU 42b accesses the VRAM 42d to create game image data for drawing.

In this embodiment, a description is made on a case that the GPU 42b generates game image data, but in a case of executing an arbitrary application except for the game application, the GPU 42b generates image data as to the arbitrary application.

Furthermore, the DSP 42c functions as an audio processor, and generates audio data corresponding to a sound, a voice, music, or the like by means of the sound data and the sound wave (tone) data stored in the internal main memory 42e and the external main memory 46.

The game image data and audio data generated as described above are read by the AV IC 56, and output to the monitor 34 and the speaker 34a via the AV connector 58. Accordingly, a game screen is displayed on the monitor 34, and a sound (music) necessary for the game is output from the speaker 34a.

Furthermore, the input-output processor 42a is connected with an expansion connector 60 and a connector for memory card 62 as well as a flash memory 44, radio communication module 50 and a radio controller module 52. The radio communication module 50 is connected with an antenna 50a, and the radio controller module 52 is connected with an antenna 52a.

The input-output processor 42a can communicate with other game apparatuses and various servers to be connected to a network via a radio communication module 50. It should be noted that it is possible to directly communicate with other game apparatus without going through the network. The input-output processor 42a periodically accesses the flash memory 44 to detect the presence or absence of data (referred to as transmission data) being required to be transmitted to a network, and, in a case that the transmission data is present, transmits it to the network via the radio communication module 50 and the antenna 50a. Furthermore, the input-output processor 42a receives data (referred to as reception data) transmitted from other game apparatuses via the network, the antenna 50a and the radio communication module 50, and stores the reception data in the flash memory 44. If the reception data does not satisfy a predetermined condition, the reception data is abandoned as it is. In addition, the input-output processor 42a receives data (download data) downloaded from the download server via the network, the antenna 50a and the radio communication module 50, and store the download data in the flash memory 44.

Also, the input/output processor 42a receives input data to be transmitted from the controller 22 or the load controller 36, through the antenna 52a and the wireless controller module 52 and stores (temporarily stores) the input data in a buffer area of the internal main memory 42e or the external main memory 46. The input data is deleted from the buffer area after being used for game processing by the CPU 40.

Note that in the present embodiment, as described above, the wireless controller module 52 communicates with the controller 22 and the load controller 36 according to the Bluetooth standard.

In addition, for the convenience of the drawing, in FIG. 2, controller 22 and controller 36 are collectively described.

In addition, the input-output processor 42a is connected with the expansion connector 60 and the connector for memory card 62. The expansion connector 60 is a connector for interfaces, such as USB, SCSI, etc., and can be connected with medium such as an external storage, and peripheral devices such as another controller. Furthermore, the expansion connector 60 is connected with a cable LAN adaptor, and can utilize the cable LAN in place of the radio communication module 50. The connector for memory card 62 can be connected with an external storage like a memory card. Thus, for example, the input-output processor 42a accesses the external storage via the expansion connector 60 and the connector for memory card 62 to store and read the data.

Though a detailed description is omitted, as is also shown in FIG. 1, the game apparatus 12 (housing 14) has the power button 20a, the reset button 20b, and the eject button 20c provided thereto. The power button 20a is connected to the system LSI 42. When the power button 20a is turned on, the system LSI 42 sets to a mode (hereinafter, referred to as a “normal mode”) in which power is supplied to each component of the game apparatus 12 through an AC adapter (not shown) and the game apparatus 12 is brought into a normal energized state. On the other hand, when the power button 20a is turned off, the system LSI 42 sets to a mode (hereinafter, referred to as a “standby mode”) in which power is supplied to some of the components of the game apparatus 12 to reduce power consumption to the minimum necessary. In the present embodiment, when a standby mode is set, the system LSI 42 instructs to stop power supply to components other than the input/output processor 42a, the flash memory 44, the external main memory 46, the ROM/RTC 48, the wireless communication module 50, and the wireless controller module 52. Hence, the standby mode is a mode in which an application is not executed by the CPU 40.

Although the system LSI 42 is supplied with power even in the standby mode, generation of clocks to the GPU 42b, the DSP 42c and the VRAM 42d are stopped so as not to be driven, realizing reduction in power consumption.

Although illustration is omitted, inside the housing 14 of the game apparatus 12, a fan is provided for excluding heat of the IC, such as the CPU 40, the system LSI 42, etc. to outside. In the standby mode, the fan is also stopped.

However, in a case that utilizing the standby mode is not desired, by making the standby mode unusable, when the power button 20a is turned off, the power supply to all the circuit components are completely stopped.

Furthermore, switching between the normal mode and the standby mode can be performed by turning on and off the power switch 26 of the controller 22 by remote control. If the remote control is not performed, setting is made such that the power supply to the radio controller module 52a is not performed in the standby mode.

The reset button 20b is also connected with the system LSI 42. When the reset button 20b is pushed, the system LSI 42 restarts the activation program of the game apparatus 12. The eject button 20c is connected to the disk drive 54. When the eject button 20c is pushed, the optical disk 18 is removed from the disk drive 54.

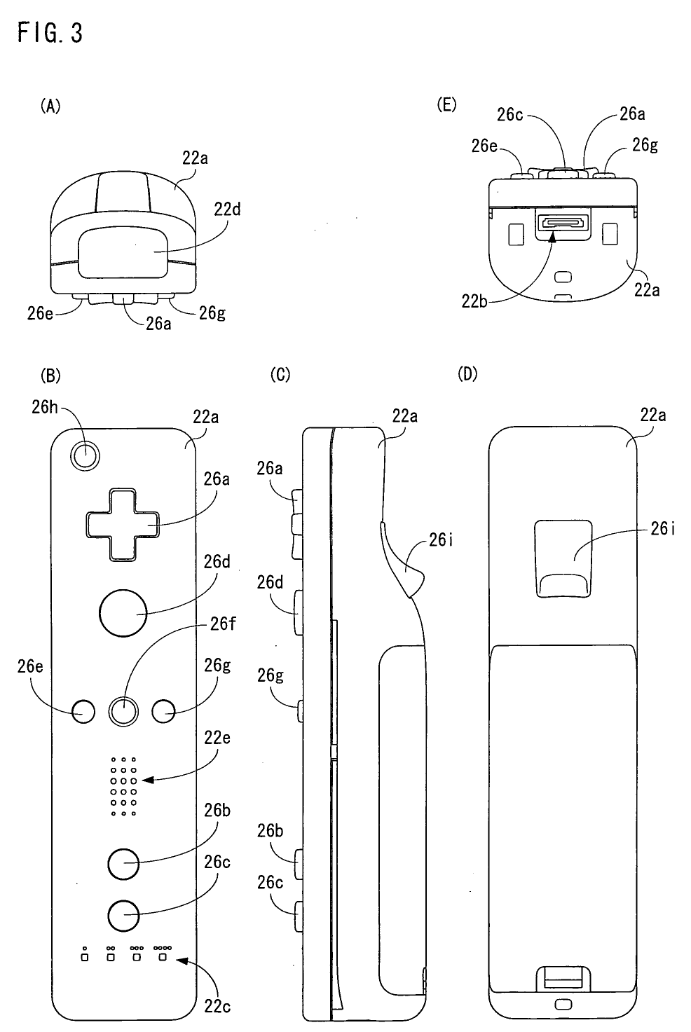

Each of FIG. 3 (A) to FIG. 3 (E) shows one example of an external appearance of the controller 22. FIG. 3 (A) shows a front end surface of the controller 22, FIG. 3 (B) shows a top surface of the controller 22, FIG. 3 (C) shows a right side surface of the controller 22, FIG. 3 (D) shows a lower surface of the controller 22, and FIG. 3 (E) shows a back end surface of the controller 22.

Referring to FIG. 3 (A) and FIG. 3 (E), the controller 22 has a housing 22a formed by plastic molding, for example. The housing 22a is formed into an approximately rectangular parallelepiped shape and has a size small enough to be held by one hand of a user. The housing 22a (controller 22) is provided with the input means (a plurality of buttons or switches) 26. Specifically, as shown in FIG. 3 (B), on an upper face of the housing 22a, there are provided a cross key 26a, a 1 button 26b, a 2 button 26c, an A button 26d, a − button 26e, a HOME button 26f, a + button 26g and a power switch 26h. Moreover, as shown in FIG. 3 (C) and FIG. 3 (D), an inclined surface is formed on a lower surface of the housing 22a, and a B-trigger switch 26i is formed on the inclined surface.

The cross key 26a is a four directional push switch, including four directions of front (or upper), back (or lower), right and left operation parts. By operating any one of the operation parts, it is possible to instruct a moving direction of a character or object (player character or player object) that is be operable by a player or instruct the moving direction of a cursor.

The 1 button 26b and the 2 button 26c are respectively push button switches, and are used for adjusting a viewpoint position and a viewpoint direction on displaying the 3D game image, i.e. a position and an image angle of a virtual camera. Alternatively, the 1 button 26b and the 2 button 26c can be used for the same operation as that of the A-button 26d and the B-trigger switch 26i or an auxiliary operation.

The A-button switch 26d is the push button switch, and is used for causing the player character or the player object to take an action other than that instructed by a directional instruction, specifically arbitrary actions such as hitting (punching), throwing, grasping (acquiring), riding, and jumping, etc. For example, in an action game, it is possible to give an instruction to jump, punch, move a weapon, and so forth. Also, in a roll playing game (RPG) and a simulation RPG, it is possible to instruct to acquire an item, select and determine the weapon and command, and so forth.

The − button 26e, the HOME button 26f, the + button 26g, and the power supply switch 26h are also push button switches. The − button 26e is used for selecting a game mode. The HOME button 26f is used for displaying a game menu (menu screen). The + button 26g is used for starting (re-starting) or pausing the game. The power supply switch 26h is used for turning on/off a power supply of the game apparatus 12 by remote control.

In this embodiment, note that the power supply switch for turning on/off the controller 22 itself is not provided, and the controller 22 is set at on-state by operating any one of the switches or buttons of the input means 26 of the controller 22, and when not operated for a certain period of time (30 seconds, for example) or more, the controller 22 is automatically set at off-state.

The B-trigger switch 26i is also the push button switch, and is mainly used for inputting a trigger such as shooting and designating a position selected by the controller 22. In a case that the B-trigger switch 26i is continued to be pushed, it is possible to make movements and parameters of the player object constant. In a fixed case, the B-trigger switch 26i functions in the same way as a normal B-button, and is used for canceling the action determined by the A-button 26d.

As shown in FIG. 3 (E), an external expansion connector 22b is provided on a back end surface of the housing 22a, and as shown in FIG. 3 (B), and an indicator 22c is provided on the top surface and the side of the back end surface of the housing 22a. The external expansion connector 22b is utilized for connecting another expansion controller not shown. The indicator 22c is made up of four LEDs, for example, and shows identification information (controller number) of the lighting controller 22 by lighting any one of the four LEDs, and shows the remaining amount of power of the controller 22 depending on the number of LEDs to be emitted.

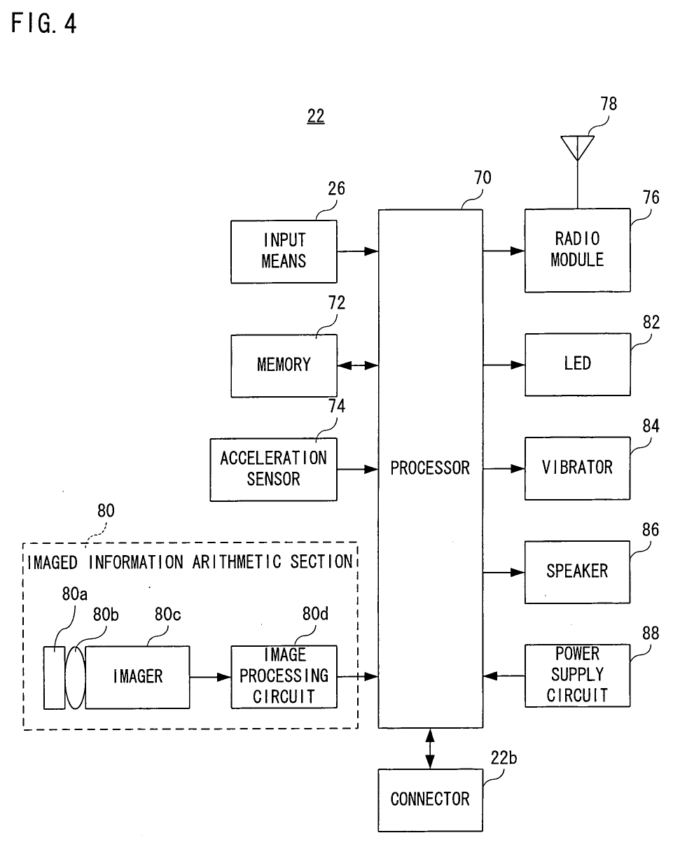

In addition, the controller 22 has an imaged information arithmetic section 80 (see FIG. 4), and as shown in FIG. 3 (A), on the front end surface of the housing 22a, light incident opening 22d of the imaged information arithmetic section 80 is provided. Furthermore, the controller 22 has a speaker 86 (see FIG. 4), and the speaker 86 is provided inside the housing 22a at the position corresponding to a sound release hole 22e between the 1 button 26b and the HOME button 26f on the tope surface of the housing 22a as shown in FIG. 3 (B).

Note that as shown in FIG. 3 (A) to FIG. 3 (E), the shape of the controller 22 and the shape, number and setting position of each input means 26 are simply examples, and needless to say, even if they are suitably modified, the present invention can be realized.

FIG. 4 is a block diagram showing an electric configuration of the controller 22. Referring to FIG. 4, the controller 22 includes a processor 70, and the processor 70 is connected with the external expansion connector 22b, the input means 26, a memory 72, an acceleration sensor 74, a radio module 76, the imaged information arithmetic section 80, an LED 82 (the indicator 22c), an vibrator 84, a speaker 86, and a power supply circuit 88 by an internal bus (not shown). Moreover, an antenna 78 is connected to the radio module 76.

The processor 70 is in charge of an overall control of the controller 22, and transmits (inputs) information (input information) inputted by the input means 26, the acceleration sensor 74, and the imaged information arithmetic section 80 as input data, to the game apparatus 12 via the radio module 76 and the antenna 78. At this time, the processor 70 uses the memory 72 as a working area or a buffer area.

An operation signal (operation data) from the aforementioned input means 26 (26a to 26i) is inputted to the processor 70, and the processor 70 stores the operation data once in the memory 72.

Moreover, the acceleration sensor 74 detects each acceleration of the controller 22 in directions of three axes of vertical direction (y-axial direction), lateral direction (x-axial direction), and forward and rearward directions (z-axial direction). The acceleration sensor 74 is typically an acceleration sensor of an electrostatic capacity type, but the acceleration sensor of other type may also be used.

For example, the acceleration sensor 74 detects the accelerations (ax, ay, and az) in each direction of x-axis, y-axis, z-axis for each first predetermined time, and inputs the data of the acceleration (acceleration data) thus detected in the processor 70. For example, the acceleration sensor 74 detects the acceleration in each direction of the axes in a range from −2.0 g to 2.0 g (g indicates a gravitational acceleration. The same thing can be said hereafter.) The processor 70 detects the acceleration data given from the acceleration sensor 74 for each second predetermined time, and stores it in the memory 72 once. The processor 70 creates input data including at least one of the operation data, acceleration data and marker coordinate data as described later, and transmits the input data thus created to the game apparatus 12 for each third predetermined time (5 msec, for example).

In this embodiment, although omitted in FIG. 3 (A) to FIG. 3 (E), the acceleration sensor 74 is provided inside the housing 22a and in the vicinity on the circuit board where the cross key 26a is arranged.

The radio module 76 modulates a carrier of a predetermined frequency by the input data, by using a technique of Bluetooth, for example, and emits its weak radio wave signal from the antenna 78. Namely, the input data is modulated to the weak radio wave signal by the radio module 76 and transmitted from the antenna 78 (controller 22). The weak radio wave signal thus transmitted is received by the radio controller module 52 provided to the aforementioned game apparatus 12. The weak radio wave thus received is subjected to demodulating and decoding processing. This makes it possible for the game apparatus 12 (CPU 40) to acquire the input data from the controller 22. Then, the CPU 40 performs game processing, following the input data and the program (game program).

In addition, as described above, the controller 22 is provided with the imaged information arithmetic section 80. The imaged information arithmetic section 80 is made up of an infrared rays filter 80a, a lens 80b, an imager 80c, and an image processing circuit 80d. The infrared rays filter 80a passes only infrared rays from the light incident from the front of the controller 22. As described above, the markers 340m and 340n placed near (around) the display screen of the monitor 34 are infrared LEDs for outputting infrared lights forward the monitor 34. Accordingly, by providing the infrared rays filter 80a, it is possible to image the image of the markers 340m and 340n more accurately. The lens 80b condenses the infrared rays passing thorough the infrared rays filter 82 to emit them to the imager 80c. The imager 80c is a solid imager, such as a CMOS sensor and a CCD, for example, and images the infrared rays condensed by the lens 80b. Accordingly, the imager 80c images only the infrared rays passing through the infrared rays filter 80a to generate image data. Hereafter, the image imaged by the imager 80c is called an “imaged image”. The image data generated by the imager 80c is processed by the image processing circuit 80d. The image processing circuit 80d calculates a position of an object to be imaged (markers 340m and 340n) within the imaged image, and outputs each coordinate value indicative of the position to the processor 70 as imaged data for each fourth predetermined time. It should be noted that a description of the process in the image processing circuit 80d is made later.

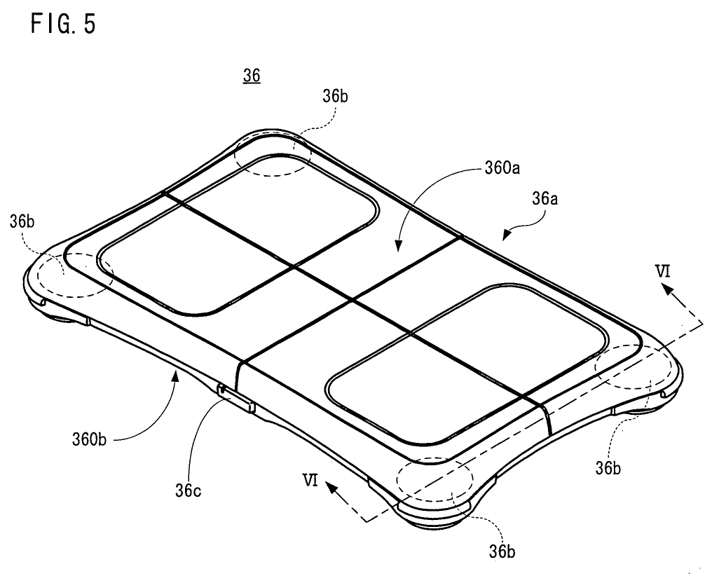

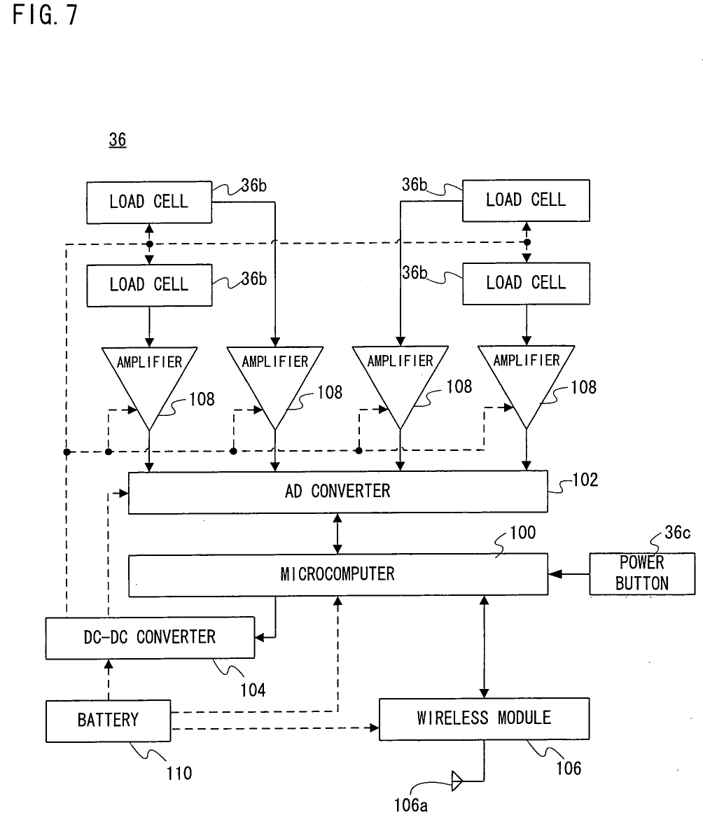

FIG. 5 is a perspective view showing an external appearance of the load controller 36 shown in FIG. 1. As shown in FIG. 5, the load controller 36 includes a board 36a a player gets on (the user puts his/her feet thereon) and at least four load sensors 36b for detecting a load imposed on the board 36a. Note that the load sensors 36b are included in the board 36a (see FIG. 7) and in FIG. 5 the disposition thereof is indicated by dashed lines.

The board 36a is formed in a substantially rectangular parallelepiped form and is substantially rectangular when viewed from the top. For example, the short side of the rectangle is set to the order of 30 cm and the long side of the rectangle is set to the order of 50 cm. A top surface of the board 36a the player gets on is made flat. Portions of a side surface at four corners of the board 36a are formed so as to partially overhang in a cylindrical manner.

In the board 36a, the four load sensors 36b are disposed with a predetermined space therebetween. In the present embodiment, the four load sensors 36b are disposed at an outer edge of the board 36a, specifically, at the four corners, respectively. The space between the load sensors 36b is set to an appropriate value such that an intention of a game operation by how the player imposes a load on the board 36a can be more accurately detected.

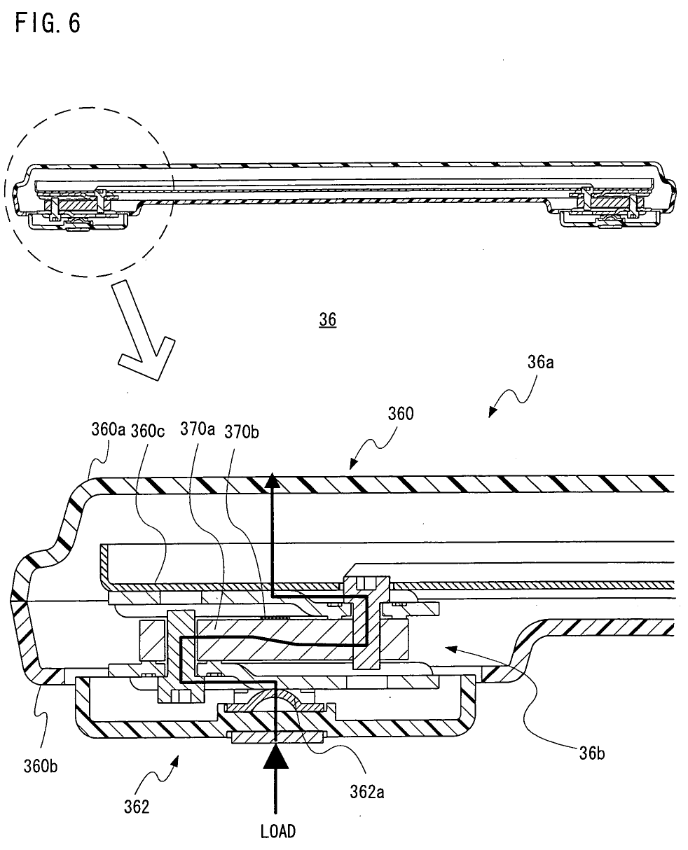

FIG. 6 is a cross-sectional view of the load controller 36 shown in FIG. 5 taken along line VI-VI and shows an enlargement of a corner portion where a load sensor 36b is disposed. As can be seen from FIG. 6, the board 36a includes a supporting plate 360 for the player to get on and legs 362. The legs 362 are respectively provided at locations where the load sensors 36b are disposed. In the present embodiment, since the four load sensors 36b are disposed at the four corners, four legs 362 are provided at the four corners. The legs 362 are formed, for example, in a substantially cylindrical form with a bottom by plastic forming and each load sensor 36b is disposed on a spherical component 362a provided in an underside of a corresponding leg 362. The supporting plate 360 is supported by the legs 362 through the load sensors 36b.

The supporting plate 360 includes an upper layer plate 360a that forms a top surface and a top side surface; a lower layer plate 360b that forms a bottom surface and a bottom side surface; and a middle layer plate 360c provided between the upper layer plate 360a and the lower layer plate 360b. The upper layer plate 360a and the lower layer plate 360b are formed, for example, by plastic forming and are combined into one unit by an adhesive or the like. The middle layer plate 360c is formed, for example, by press forming of a metal plate. The middle layer plate 360c is fixed on the four load sensors 36b. The upper layer plate 360a has lattice ribs (not shown) on its bottom surface and is supported by the middle layer plate 360c through the ribs.

Therefore, when the player gets on the board 36a, a load thereof is transferred to the supporting plate 360, the load sensors 36b, and the legs 362. As shown by an arrow in FIG. 6, a reaction occurred from the floor by a load to be inputted is transferred from the leg 362 to the upper layer plate 360a through the spherical component 362a, the load sensor 36b, and the middle layer plate 360c.

Each of the load sensors 36b is, for example, a strain gauge (strain sensor) type load cell and is a load transducer that converts an inputted load into an electrical signal. In each load sensor 36b, a strain inducing element 370a is deformed according to a load input, whereby a strain occurs. This strain is converted into a change in electrical resistance by a strain sensor 370b attached to the strain inducing element 370a and is further converted into a voltage change. Thus, the load sensors 36b output a voltage signal indicating an input load from an output terminal.

Note that each load sensor 36b may be a load sensor of other types such as a tuning fork oscillation type, a string oscillation type, a capacitance type, a piezoelectric type, a magnetostriction type, and a gyro type.

Returning to FIG. 5, the load controller 36 further includes a power button 36c. When the power button 36c is turned on, power is supplied to each circuit component (see FIG. 7) of the load controller 36. Note, however, that the load controller 36 may be turned on in response to an instruction from the game apparatus 12. When a state in which a player is not on the load controller 36 continues over a certain period of time (e.g., 30 seconds), the power to the load controller 36 is turned off. Note, however, that the power to the load controller 36 may be turned off when the power button 36c is turned on with the load controller 36 being activated.

A block diagram in FIG. 7 shows an example of an electrical configuration of the load controller 36. Note that in FIG. 7 signal and communication flows are indicated by solid line arrows. Broken line arrows indicate supply of power.

The load controller 36 includes a microcomputer 100 for controlling the operation thereof. The microcomputer 100 includes a CPU, a ROM, a RAM, etc., which are not shown, and the CPU controls the operation of the load controller 36 according to a program stored in the ROM.

To the microcomputer 100 are connected a power button 36c, an AD converter 102, a DC-DC converter 104, and a wireless module 106. Furthermore, to the wireless module 106 is connected an antenna 106a. The four load sensors 36b are represented as load cells 36b in FIG. 7. Each of the four load sensors 36b is connected to the AD converter 102 through a corresponding amplifier 108.

The load controller 36 also contains a battery 110 for power supply. In another embodiment, instead of the battery, an AC adapter may be connected to supply utility power. In such a case, instead of the DC-DC converter, a power supply circuit that converts alternating current into direct current and steps down and rectifies direct-current voltage needs to be provided. In the present embodiment, power to the microcomputer 100 and the wireless module 106 is directly supplied from the battery. That is, power is always supplied to a component (CPU) in the microcomputer 100 and the wireless module 106 and it is detected whether the power button 36c is turned on or whether a power-on (load detection) command is transmitted from the game apparatus 12. Meanwhile, to the load sensors 36b, the AD converter 102, and the amplifiers 108 is supplied power from the battery 110 through the DC-DC converter 104. The DC-DC converter 104 converts a voltage value of a direct current from the battery 110 into a different voltage value and provides it to the load sensors 36b, the AD converter 102, and the amplifiers 108.

Power supply to the load sensors 36b, the AD converter 102, and the amplifiers 108 may be performed as necessary by control of the DC-DC converter 104 by the microcomputer 100. Specifically, when it is determined that the load sensors 36b need to be operated to detect a load, the microcomputer 100 may control the DC-DC converter 104 to supply power to each load sensor 36b, the AD converter 102, and each amplifier 108.

When power is supplied, each load sensor 36b outputs a signal indicating an inputted load. The signal is amplified by a corresponding amplifier 108, the amplified signal is converted by the AD converter 102 from an analog signal to digital data, and the digital data is inputted to the microcomputer 100. Identification information on each load sensor 36b is provided to a detected value of each load sensor 36b to enable to identify of which load sensor 36b a detection value is. In this manner, the microcomputer 100 can obtain data indicating load detected values of the respective four load sensors 36b at an identical time.

On the other hand, when it is determined that the load sensors 36b do not need to be operated, i.e., when it is not load detection timing, the microcomputer 100 controls the DC-DC converter 104 to stop power supply to the load sensors 36b, the AD converter 102, and the amplifiers 108. As such, in the load controller 36, since load detection can be performed only when necessary by operating the load sensors 36b, power consumption for load detection can be suppressed.

When load detection is necessary is typically when the game apparatus 12 (FIG. 1) needs to obtain load data. For example, when the game apparatus 12 needs load information, the game apparatus 12 transmits a load obtaining instruction to the load controller 36. The microcomputer 100 controls, when receiving the load obtaining instruction from the game apparatus 12, the DC-DC converter 104 to supply power to the load sensors 36b and the like, and detects a load. On the other hand, when the load obtaining instruction is not received from the game apparatus 12, the microcomputer 100 controls the DC-DC converter 104 to stop power supply. Alternatively, the microcomputer 100 may control the DC-DC converter 104 such that the microcomputer 100 determines every certain period of time that it is load detection timing. When periodically obtaining a load in this manner, period information may be provided to the microcomputer 100 from the game apparatus 12 first or may be stored in the microcomputer 100 in advance, for example.

Data indicating detected values from the load sensors 36b is transmitted from the microcomputer 100 to the game apparatus 12 (FIG. 1) through the wireless module 106 and the antenna 106a, as operation data (input data) of the load controller 36. For example, when load detection is performed in response to an instruction from the game apparatus 12, the microcomputer 100 transmits, when receiving detected value data of the load sensors 36b from the AD converter 102, the detected value data to the game apparatus 12. Alternatively, the microcomputer 100 may transmit detected value data to the game apparatus 12 every certain period of time.

Note that the wireless module 106 is made communicable by the same wireless standard (Bluetooth, a wireless LAN, or the like) as that used by the wireless controller module 52 of the game apparatus 12. Hence, the CPU 40 of the game apparatus 12 can transmit a load obtaining instruction to the load controller 36 through the wireless controller module 52 or the like. The microcomputer 100 of the load controller 36 can receive an instruction from the game apparatus 12 and transmit input data including load detected values (or load calculated values) of the respective load sensors 36b to the game apparatus 12, through the wireless module 106 and the antenna 106a.

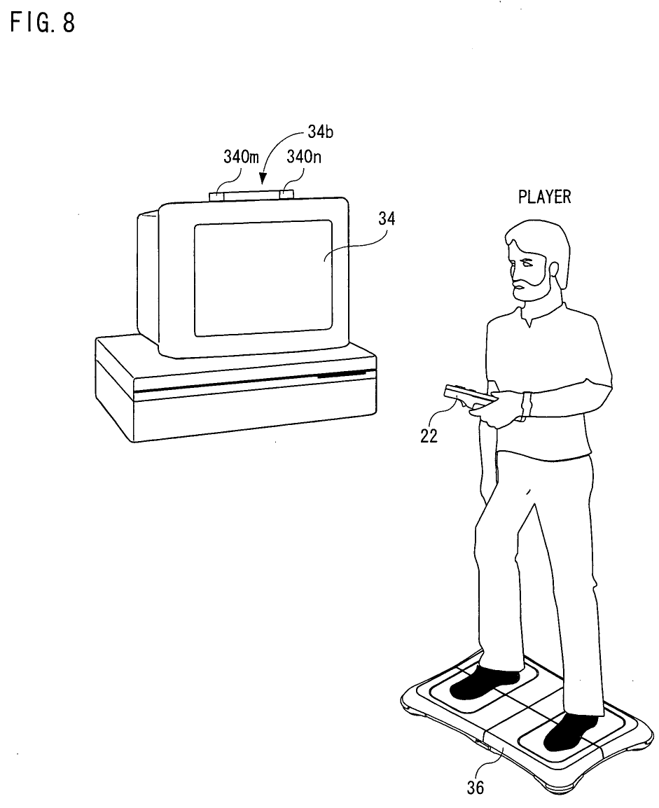

FIG. 8 is an illustrative view generally describing a state for when a game is played using the controller 22 and the load controller 36. As shown in FIG. 8, in the video game system 100, when a game is played using the controller 22 and the load controller 36, a player gets on the load controller 36 and holds the controller 22 with one hand. Strictly speaking, the player gets on the load controller 36 and holds the controller 22 with a front edge surface (the side of the light entering opening 22d where the imaging information computing unit 80 performs imaging) of the controller 22 being directed to markers 340 m and 340 n. Note that, as can also be seen from FIG. 1, the markers 340 m and 340 n are disposed in parallel to a horizontal direction of a screen of the monitor 34. In this state, the player performs a game operation by changing a location on the screen instructed by the controller 22 or changing the distance between the controller 22 and each of the markers 340 m and 340 n.

Note that although in FIG. 8 the load controller 36 is placed in a vertical orientation such that the player faces sideward relative to the screen of the monitor 34, depending on the game, the load controller 36 may be placed in a horizontal orientation such that the player faces the front side relative to the screen of the monitor 34.

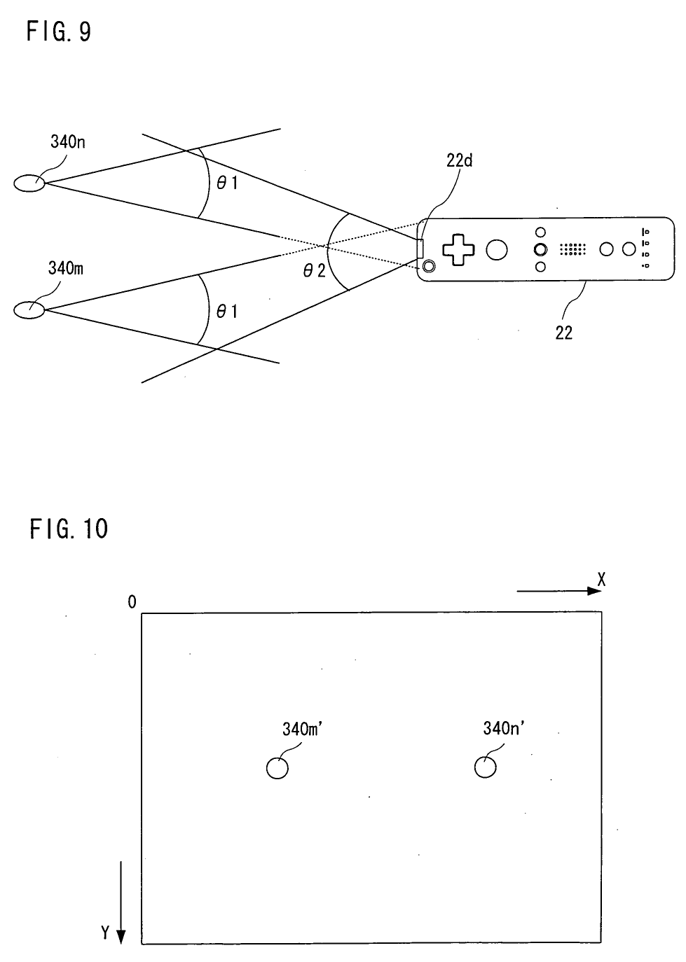

FIG. 9 is a view showing viewing angles between the respective markers 340m and 340n, and the controller 22. As shown in FIG. 9, each of the markers 340m and 340n emits infrared ray within a range of a viewing angle θ1. Also, the imager 80c of the imaged information arithmetic section 80 can receive incident light within the range of the viewing angle θ2 taking the line of sight of the controller 22 as a center. For example, the viewing angle θ1 of each of the markers 340m and 340n is 34° (half-value angle) while the viewing angle θ2 of the imager 80c is 41°. The player holds the controller 22 such that the imager 80c is directed and positioned so as to receive the infrared rays from the markers 340m and 340n. More specifically, the player holds the controller 22 such that at least one of the markers 340m and 340n exists in the viewing angle θ2 of the imager 80c, and the controller 22 exists in at least one of the viewing angles θ1 of the marker 340m or 340n. In this state, the controller 22 can detect at least one of the markers 340m and 340n. The player can perform a game operation by changing the position and the orientation of the controller 22 in the range satisfying the state.

If the position and the orientation of the controller 22 are out of the range, the game operation based on the position and the orientation of the controller 22 cannot be performed. Hereafter, the above-described range is called an “operable range.”

If the controller 22 is held within the operable range, an image of each of the markers 340m and 340n is imaged by the imaged information arithmetic section 80. That is, the imaged image obtained by the imager 80c includes an image (object image) of each of the markers 340m and 340n as an object to be imaged. FIG. 10 is a view showing one example of the imaged image including an object image. The image processing circuit 80d calculates coordinates (marker coordinates) indicative of the position of each of the markers 340m and 340n in the imaged image by utilizing the image data of the imaged image including the object image.

Since the object image appears as a high-intensity part in the image data of the imaged image, the image processing circuit 80d first detects the high-intensity part as a candidate of the object image. Next, the image processing circuit 80d determines whether or not the high-intensity part is an object image on the basis of the size of the detected high-intensity part. The imaged image may include images other than the object image due to sunlight through a window and light of a fluorescent lamp in the room as well as the images 340m′ and 340n′ of the two markers 340m and 340n as an object image. The determination processing whether or not the high-intensity part is an object image is executed for discriminating the images 340m′ and 340n′ of the two markers 340m and 340n as an object image from the images other than them, and accurately detecting the object image. More specifically, in the determination process, it is determined whether or not the detected high-intensity part is within the size of the preset predetermined range. Then, if the high-intensity part is within the size of the predetermined range, it is determined that the high-intensity part represents the object image. On the contrary, if the high-intensity part is not within the size of the predetermined range, it is determined that the high-intensity part represents the images other than the object image.

In addition, as to the high-intensity part which is determined to represent the object image as a result of the above-described determination processing, the image processing circuit 80d calculates the position of the high-intensity part. More specifically, the barycenter position of the high-intensity part is calculated. Here, the coordinates of the barycenter position is called a “marker coordinate”. Also, the barycenter position can be calculated with more detailed scale than the resolution of the imager 80c. Now, the resolution of the imaged image imaged by the imager 80c shall be 126×96, and the barycenter position shall be calculated with the scale of 1024×768. That is, the marker coordinate is represented by the integer from (0, 0) to (1024, 768).

Additionally, the position in the imaged image shall be represented by a coordinate system (XY coordinate system) taking the upper left of the imaged image as an origin point, the downward direction as an Y-axis positive direction, and the right direction as an X-axis positive direction.

Also, if the object image is properly detected, two high-intensity parts are determined as an object image by the determination process, and therefore, two marker coordinates are calculated. The image processing circuit 80d outputs data indicative of the calculated two marker coordinates. The data (marker coordinate data) of the output marker coordinates is included in the input data by the processor 70 as described above, and transmitted to the game apparatus 12.

The game apparatus 12 (CPU 40) detects the marker coordinate data from the received input data to thereby calculate an instructed position (instructed coordinate) by the controller 22 on the screen of the monitor 34 and a distances from the controller 22 to each of the markers 340m and 340n on the basis of the marker coordinate data. More specifically, from the position of the mid point of the two marker coordinates, a position to which the controller 22 faces, that is, an instructed position is calculated. The distance between the object images in the imaged image is changed depending on the distance between the controller 22 and each of the markers 340m and 340n, and therefore, the game apparatus 12 can grasp the distance between the controller 22 and each of the markers 340m and 340n by calculating the distance between the two marker coordinates.

As described above, when a game is played using the controller 22 and the load controller 36, game processing can be performed based on a load value to be detected by the load controller 36. In the present embodiment, when a game is started, prior to starting the main content, a weight value of a player is set (stored in the main memory 42e or 46) as a reference value and game processing is performed based on, for example, a difference between the set reference value and a load value to be detected. That is, the weight value of the player serves as a reference value for when game processing is performed.

Therefore, while a game is being played, a reference value is fixedly set and the game proceeds such that a change in load value brought about by a change (change such that the weight is shifted from front to back, left to right, or up to down) in the posture of a player being on the load controller 36 is detected based on the reference value and a detected value is used as an input. Thus, when the same player repeatedly plays the same game or continuously plays a different game, by performing game processing directly using a reference value that is set once, game processing based on a proper reference value is performed.

However, if a player is changed to another player in midstream, when a weight value indicated by a reference value is different from a weight value of another player, game processing cannot be performed based on a proper reference value. That is, after a player is changed to another player, game processing is not properly performed. Particularly when the weight is significantly different between players before and after a change, it is considered that game processing that does not follow a player's instruction may be performed.

Therefore, in the present embodiment, when a game is started, prior to starting the main content, a load value (weight value) of a player is measured and if the measured load value does not match a registered reference value, then it is determined that a player is changed to another player and thus the reference value is set again.

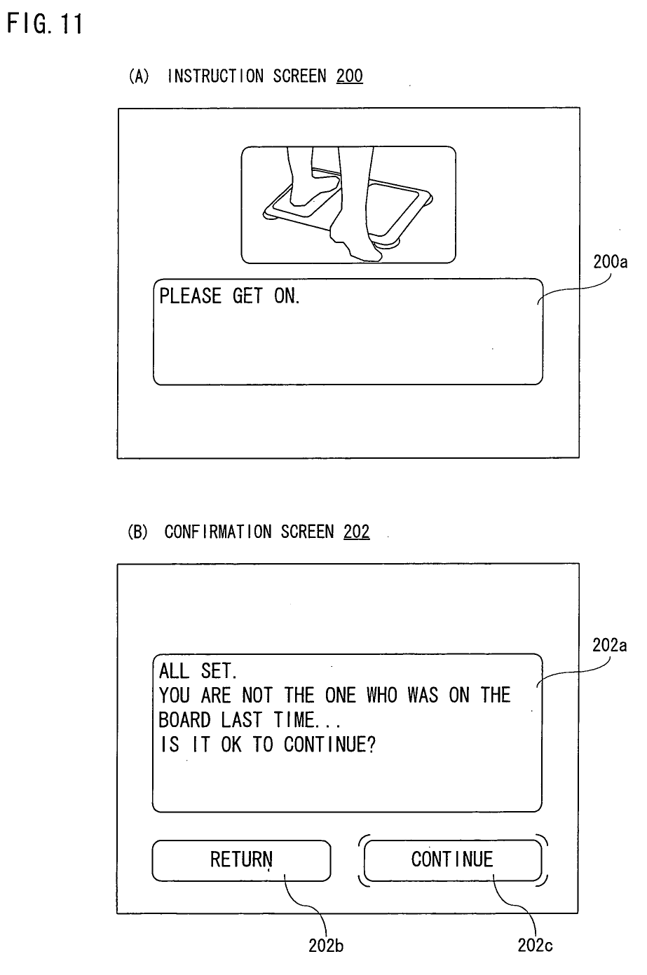

For example, prior to starting the main content of a game, an instruction screen 200 such as that shown in FIG. 11(A) is displayed on the monitor 34. The instruction screen 200 has a message display area 200a. In the message display area 200a, a message instructing to get on the load controller 36 is displayed. Note that in the instruction screen 200 an image showing a scene in which the player puts his/her feet on the load controller 36 is displayed above the message display area 200a.

When the player gets on the load controller 36, a load value is detected by each load sensor 36b, and data on the load values is transmitted (provided) to the game apparatus 12, a total value (weight value) of the load values detected by the respective load sensors 36b is set as a reference value of the weight value of the player.

Note, however, that when the reference value is already set, the weight value detected this time is compared with the reference value. When the weight value detected this time matches the reference value (the difference is within a certain range), it is determined that a player has not been changed to another player or a player has been changed to another player whose weight happens to be the same or substantially the same as the player and thus the main content of the game starts. This is because in such a case there is no need to change the setting of a weight value that serves as the reference value.

On the other hand, when the weight value detected this time does not match the reference value (the difference exceeds the certain range), it is determined that a player has been changed to another player and thus a confirmation screen 202 such as that shown in FIG. 11(B) is displayed on the monitor 34. As shown in FIG. 11(B), in the confirmation screen 202, a message display area 202a is provided and therebelow a button image 202b and a button image 202c are displayed. In the message display area 202a, a message is displayed that tells the player that a weight value has been detected and the detected weight value does not match a set reference value, and that asks the player whether to continue game play. When the player turns on (clicks) the button 202b using the controller 22, the game is redone from the start. In such a case, for example, it is a player's mistake and it is not a player change and thus a selection is made that a player who has played immediate last time plays the game. On the other hand, when the player turns on the button 202c using the controller 22, the game play continues. In such a case, since a player is changed to another player, the detected weight value is set as the reference value. That is, the reference value is updated. In such a case, a selection is made that the current player plays the game.

Note that the reason that the confirmation screen 202 is thus displayed to allow a desired player to play a game is that, for example, game data may be saved or updated on a player-by-player basis.

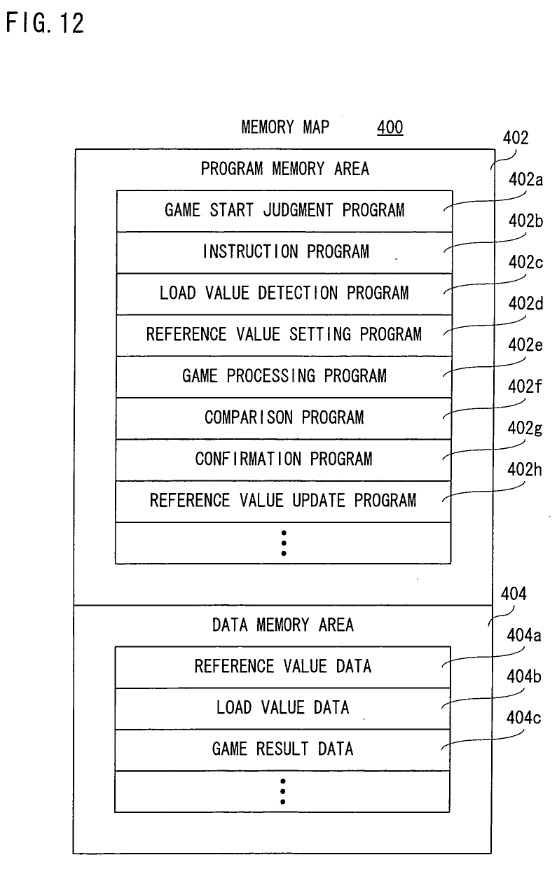

FIG. 12 shows an example of a memory map 400 of the main memory 42e (or 46). As shown in FIG. 12, the main memory 42e (46) has a program memory area 402 and a data memory area 404. In the program memory area 402, a load detection program is stored. The load detection program includes a game start judgment program 402a, an instruction program 402b, a load value detection program 402c, a reference value setting program 402d, a game processing program 402e, a comparison program 402f, a confirmation program 402g, a reference value update program 402h, and the like.

The game start judgment program 402a is a program for judging whether a game (game processing) is started. The instruction program 402b is a program for instructing a player to get on the load controller 36 when it is judged according to the game start judgment program 402a that a game is started. Specifically, according to the instruction program 402b, an instruction screen 200 such as that shown in FIG. 11(A) is displayed on the monitor 34.

The load value detection program 402c is a program for providing a load value detection instruction to the load controller 36, and obtaining data on a load value (load value data 404b) to be transmitted from the load controller 36 and storing the obtained load value data 404b in the data memory area 404. The reference value setting program 402d is a program for determining, when a load value (load value data 404b) is detected according to the load value detection program 402c, whether a reference value (reference value data 404a) is set (stored) and storing, if the reference value data 404a is not stored, the load value data 404b detected this time in the data memory area 404 as the reference value data 404a.

The game processing program 402e is a program for performing game processing based on the reference value data 404a and the load value data 404b. In the game processing, for example, operation control is performed such as moving a player character, attacking an enemy character, adding a point, or determining whether a game is over. In addition, a game screen showing such a scene is generated and displayed (updated) on the monitor 34 and sounds such as character voices, game music (BGM, etc.), and sound effects are generated and outputted from the speaker 34a. Furthermore, game data (midway data or result data) to be stored in the main memory 42e (or 46) is stored (saved) in the flash memory 44, a memory card mounted in the external memory card connector 62, or the like. That is, though not shown, the game processing program 402e includes a game main processing program that processes a main routine of the game, an image generation and display program, a sound generation and output program, a backup program, and the like.

The comparison program 402f is a program for comparing, when upon starting a game load value data 404b is detected according to the load value detection program 402c and reference value data 404a is stored in the memory (data memory area 404), a reference value indicated by the reference value data 404a with a load value indicated by the load value data 404b. The confirmation program 402g is a program for informing, when a comparison result according to the comparison program 402f shows a mismatch, the player that a different player is on the load controller 36 and confirming whether to continue the game. Specifically, according to the confirmation program 402g, a confirmation screen 202 such as that shown in FIG. 11(B) is displayed on the monitor 34. Note, however, that even if the player is the same one, a load value may not match the reference value because of a different posture or measurement error, and thus, in the present embodiment, a determination as to whether a load value matches the reference value is made with an allowance of a certain range (width). The certain range is determined by experiment or the like and is set within ±2 kg in the present embodiment.

The reference value update program 402h is a program for storing (updating), when it is confirmed according to the confirmation program 402g that the game continues, the load value data 404b detected this time in the data memory area 404 as the reference value data 404a.

In the data memory area 404, reference value data 404a, load value data 404b, and game result data 404c are stored. The reference value data 404a is numeric value data about a reference value of a weight value of a player. The load value data 404b is numeric value data about a total value (weight value) of load values detected by the respective load sensors 36b. The game result data 404c is midway data or result data on the game and is data indicating a game proceeding status such as a score, a level (assessment), etc., of a player (player character).

Though not shown, in the data memory area 404, other data such as image data and sound data, a flag, a counter (timer), etc., are also stored.

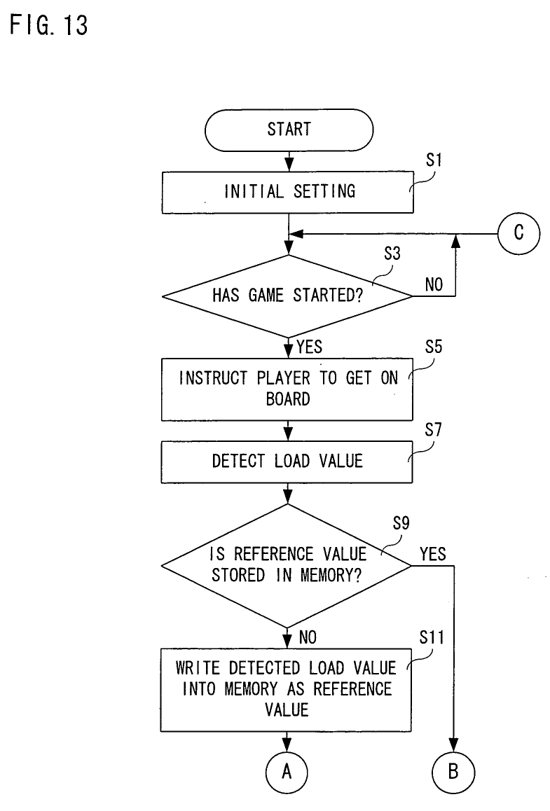

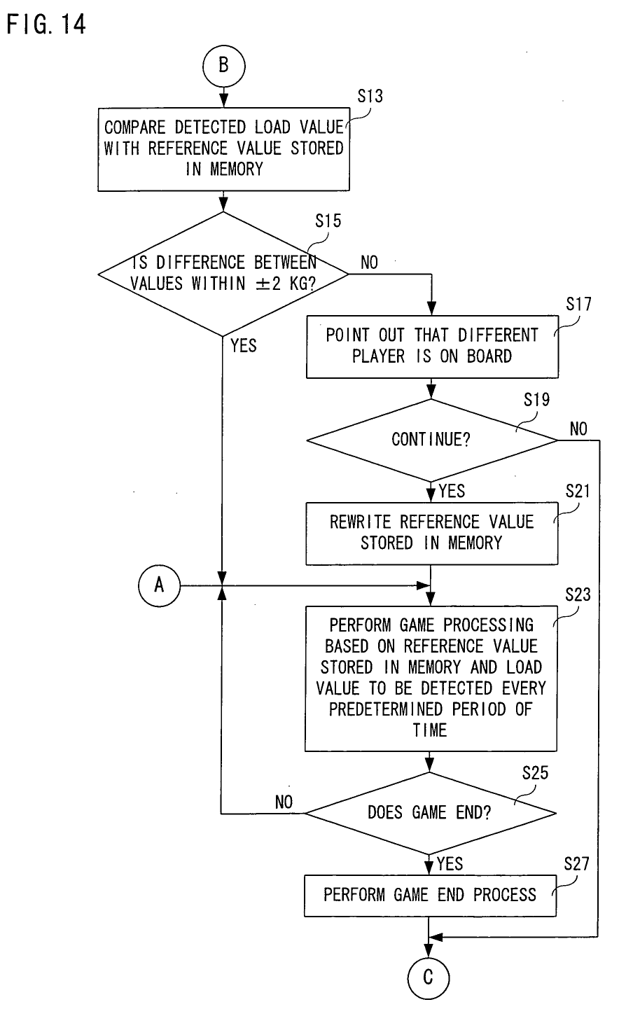

FIGS. 13 and 14 are flowcharts showing an overall process of the CPU 40 shown in FIG. 2. As shown in FIG. 13, when the CPU 40 starts the overall process, in a step S1, the CPU 40 performs initial setting. Though a detailed description is omitted, in this step, the data memory area 404 is initialized and a counter (timer) and a flag are reset. In a subsequent step S3, it is determined whether a game has started. In this step, a player inputs an instruction to start a game and according to the input it is determined whether a game has started. If “NO” in the step S3, i.e., if a game has not started, then the process returns to the same step S3.

On the other hand, if “YES” in the step S3, i.e., if a game has started, then prior to starting the main content, in a step S5, the player is instructed to get on the board 36a (load controller 36). In this step, the CPU 40 displays an instruction screen 200 such as that shown in FIG. 11(A) on the monitor 34. In a subsequent step S7, a load value is detected. In this step, the CPU 40 transmits a load value detection command to the load controller 36 and accordingly receives data (load value data 404b) transmitted from the load controller 36 and stores the data in the main memory 42e (46).

Then, in a step S9, it is determined whether a reference value is stored in the memory. Specifically, the CPU 40 determines whether reference value data 404a is stored in the data memory area 404 of the main memory 42e (46). If “YES” in the step S9, i.e., if a reference value is stored in the memory, then it is determined that the reference value is already set and thus the process proceeds to a step S13 shown in FIG. 14. On the other hand, if “NO” in the step S9, i.e., if a reference value is not stored in the memory, then it is determined that the reference value is not yet set and thus in a step S11 the detected load value is written into the memory as a reference value of a weight value of the player and the process proceeds to a step S23 shown in FIG. 14. Specifically, in the step S11, the CPU 40 stores (copies) the load value data 404b as the reference value data 404a.

As shown in FIG. 14, in the step S13, the detected load value is compared with the reference value stored in the memory. Specifically, the CPU 40 detects a difference between a load value indicated by the load value data 404b and a reference value indicated by the reference value data 404a. In a subsequent step S15, it is determined whether the difference between the values is within ±2 kg. If “YES” in the step S15, i.e., if the difference between the values is within ±2 kg, then it is determined that a player has not been changed to another player and thus the process proceeds to the step S23.

On the other hand, if “NO” in the step S15, i.e., if the difference between the values exceeds ±2 kg, then it is determined that a player has been changed to another player and thus in a step S17 it is pointed out that a different player is on the load controller 36. In this step, the CPU 40 displays a confirmation screen 202 such as that shown in FIG. 11(B) on the monitor 34. In a subsequent step S19, it is determined whether to continue the game. Specifically, the CPU 40 determines whether a button 202b is turned on or a button 202c is turned on in the confirmation screen 202.

Note that although in the step S19 it is determined whether the button 202b or the button 202c is turned on, when neither of the buttons 202b and 202c is turned on, the CPU 40 waits for a player's input (selection) with the confirmation screen 202 being displayed.

If “NO” in the step S19, i.e., if the button 202b is turned on, then it is determined that it is a player's mistake and it is not a player change and thus the process returns to the step S3 shown in FIG. 13. On the other hand, if “YES” in the step S19, i.e., if the button 202c is turned on, then it is determined that the game continues with a different player and thus in a step S21 the reference value stored in the memory is rewritten. Specifically, the CPU 40 stores (overwrites) the load value data 404b in the data memory area 404 as the reference value data 404a.

Subsequently, in a step S23, game processing is performed based on the reference value stored in the memory and a load value to be detected every predetermined period of time. Specifically, the CPU 40 starts the main content of the game and thereafter detects a load value every predetermined period of time and proceeds the game using the load value and the reference value. Then, in a step S25, it is determined whether the game ends. In this step, the CPU 40 determines whether the game has been cleared or whether the game has been over or whether an instruction to end the game has been inputted from the player.

If “NO” in the step S25, i.e., if the game does not end, then the process returns to the step S23 and continues the game processing. On the other hand, if “YES” in the step S25, then in a step S27 a game end process is performed and the process returns to the step S3. For example, in the step S27, operations such as saving game result data 404c and ending the main content of the game are performed.

According to the present embodiment, since a load value detected upon starting a game is compared with a set reference value of a weight value of a player, it is possible to know based on a comparison result whether a player has been changed to another player. When a player is changed to another player, the reference value is updated using a weight value of another player and thus even when a player has been changed to another player, game processing can be properly performed.

Note that although the present embodiment describes the case of using both the controller 22 and the load controller 36, the present invention is not necessarily limited thereto. The controller 22 may not be used. In such a case, the marker portion 34b does not need to be provided.

Note also that although in the present embodiment game processing is performed using the load controller 36, various information processing including other applications can also be performed.

In the above-described embodiment, during the execution of the main content of a game, the game is played with a reference value being fixed. With this, when a player has been changed to another player during the execution of the main content of a game, an invalid input is accepted and thus game processing cannot be properly performed. Therefore, in another embodiment (second embodiment), even when a player has been changed to another player during the execution of the main content of a game, a reference value is updated and thus game processing can be properly performed.

### Second Embodiment

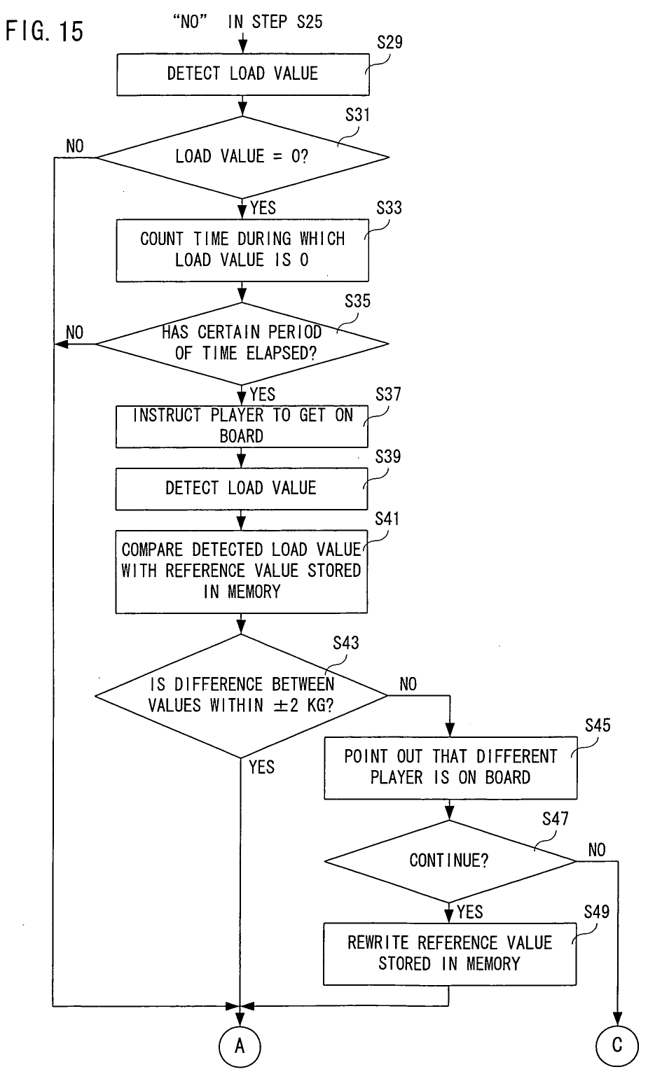

A second embodiment is the same as the above-described first embodiment except that part of the overall process of the CPU 40 is different and thus overlapping description is omitted here. Specifically, a flowchart shown in FIG. 15 is added to the overall process shown in FIGS. 13 and 14. The process will be specifically described below but the same operations as those described above will be briefly described.

The flowchart in FIG. 15 is inserted between where it is determined to be “NO” in the step S25 shown in FIG. 14 and where the process returns to the step S23. If “NO” in the step S25, i.e., if the game does not end, then in a step S29, a load value is detected. In a subsequent step S31, it is determined whether the load value is 0. In this step, the CPU 40 determines whether a load value indicated by load value data 404b is 0 to determine whether no player is on the load controller 36.

If “NO” in the step S31, i.e., if the load value is not 0, then it is determined that a player is on the load controller 36 and thus the process returns to the step S23. On the other hand, if “YES” in the step S31, i.e., the load value is 0, then it is determined that no player is on the load controller 36 and thus in a step S33, time during which the load value is 0 is counted. Note that when the operation in the step S33 is performed first, counting of time during which the load value is 0 is started (a timer not shown is started).

In a subsequent step S35, it is determined whether a certain period of time has elapsed. In this step, the CPU 40 determines whether the state in which the load value is 0 is maintained over a certain period of time (e.g., 10 seconds). Note that the certain period of time is time considered to be required for a player change and thus a different value may be set depending on the game being executed. This is because depending on the game, operations may be required such as a player getting off the load controller 36 once in midstream and then getting on the load controller 36 again.

If “NO” in the step S35, i.e., if a certain period of time has not elapsed, then the process returns to the step S23. On the other hand, if “YES” in the step S35, i.e., if a certain period of time has elapsed, then it is determined that there is a possibility of a player change and thus in a step S37, the player is instructed to get on the board. In a subsequent step S39, a load value is detected and in a step S41, the detected load value is compared with the reference value stored in the memory.

Then, in a step S43, it is determined whether a difference between the values is within ±2 kg. If “YES” in the step S43, then it is determined that a player has not been changed to another player and thus the process returns to the step S23. On the other hand, if “NO” in the step S43, then it is determined that a player has been changed to another player and thus in a step S45 it is pointed out that a different player is on the board, and in a step S47 it is determined whether to continue the game. If “NO” in the step S47, then it is determined that it is a player's mistake and it is not a player change and thus the process returns to the step S3 shown in FIG. 13. On the other hand, if “YES” in the step S47, then it is determined that it is a player change and thus in a step S49, the reference value stored in the memory is rewritten and then the process returns to the step S23.

According to the second embodiment, when a player is changed to another player, there is time (period of time during which a load value is 0) after a previous player has got off the load controller and before a next player gets on the load controller, and thus, by judging this period of time, even during the execution of the main content of a game, a player change is detected and a proper weight value is set as a reference value, and accordingly, proper game processing can be performed.

Note that although in this another embodiment it is checked whether a player has been changed to another player according to the fact that a state in which a load value detected by the load controller 36 is 0 is maintained over a certain period of time, it is also possible to check whether a player has been changed to another player according to game processing. This is because, for example, when a plurality of players play a game in turn, a player change instruction may be provided from the game apparatus 12 side during the execution of the main content of the game.

Note also that although in this another embodiment it is checked whether a player has been changed to another player according to the fact that a state in which a load value detected by the load controller 36 is 0 is maintained over a certain period of time, it is also possible to check whether a player has been changed to another player according to the fact that a state in which a load value is less than or equal to a predetermined value (e.g., 5 kg or less) is maintained over a certain period of time. By doing so, even when a load value does not completely become 0 due to error of a detected value or the like, or even when a change is made such that before a previous player finishes getting off the load controller 36, a next player starts getting on the load controller 36 (i.e., a change is made such that a period of time during which a load value is 0 is not detected), appropriate detection can be performed.

### Third Embodiment

A third embodiment is the same as the first embodiment except that a weight value of a player is registered and the registered weight value can be set as a reference value (reference value data 404a) and thus overlapping description is omitted here.

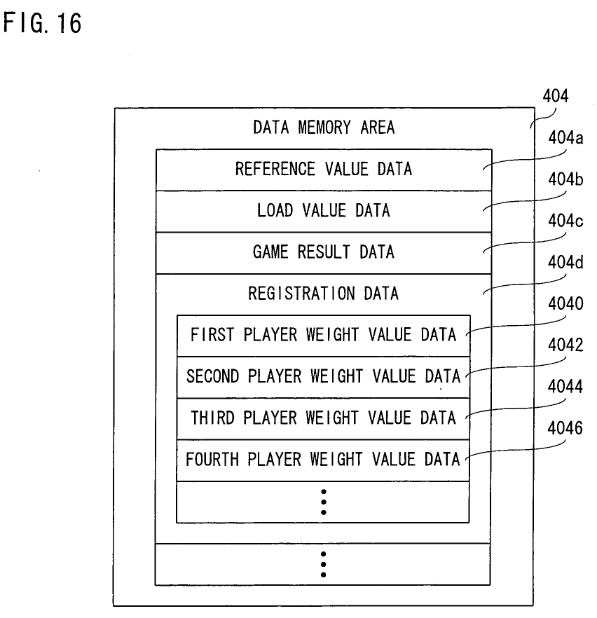

As shown in FIG. 16, in a data memory area 404, registration data 404d is further stored. The registration data 404d includes weight value data for each registered player. Specifically, the registration data 404d includes first player weight value data 4040, second player weight value data 4042, third player weight value data 4044, fourth player weight value data 4046, and the like.

Note that although there are various ways to register a player weight value, when starting a game first, a new registration selection screen (not shown) allowing a player to select whether to newly register a weight value is displayed and when registration is selected, an instruction screen 200 such as that shown in FIG. 11(A) is displayed on the monitor 34, and thereafter, a load value detected by the load controller 36 is registered as a weight value of the player. At this time, the weight value is registered in association with a name (player's name, nickname, alias, etc.) specified by the player.

Therefore, when a load value is detected upon starting a game and the detected load value does not match a set reference value (when the difference exceeds a range of ±2 kg), a search is performed to see whether a player of a weight value that matches the detected load value (the difference is within the range of ±2 kg) is registered.

When a player of a weight value that matches the detected load value is registered, it is confirmed whether the player is on the load controller 36. When, as a result of the confirmation, it is determined that a different player is on the load controller 36, it is pointed out, as shown in the first embodiment, that a different player is on the load controller 36 and then it is determined whether to continue the game. On the other hand, when, as a result of the confirmation, it is determined that the player is on the load controller 36, a weight value (or the load value detected this time) of the player is set as the reference value.

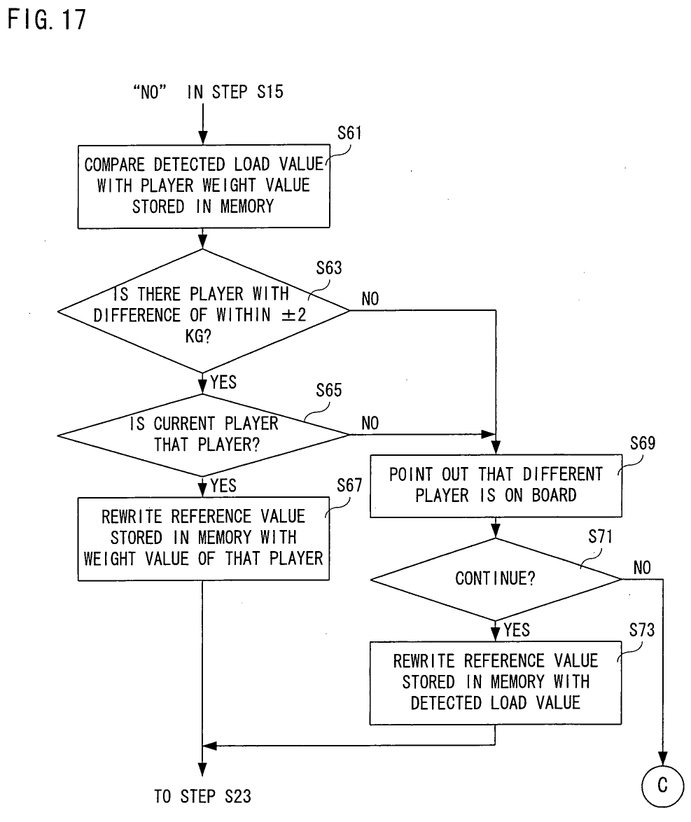

Specifically, an overall process is performed such that the operations in the steps S17, S19, and S21 in the flowcharts shown in FIGS. 13 and 14 are replaced by a flowchart shown in FIG. 17. The process shown in FIG. 17 will be described below but the same operations as those described in the first embodiment will be briefly described.

As shown in FIG. 14, if “NO” in the step S15, i.e., if the detected load value does not match the reference value registered in the memory, then in a step S61, the detected load value is compared with a player weight value stored in the memory. In this step, when weight values of a plurality of players are registered, the detected load value is compared with each of the weight values.

Then, in a step S63, it is determined whether, as a result of the comparison, there is a player with a difference of within ±2 kg. If “NO” in the step S63, i.e., if there is no player with a difference of within ±2 kg, then it is determined that a player who is not registered is on the load controller 36 and thus the process proceeds to a step S69. On the other hand, if “YES” in the step S63, i.e., if there is a player with a difference of within ±2 kg, then in a step S65, it is determined whether the current player is that player.

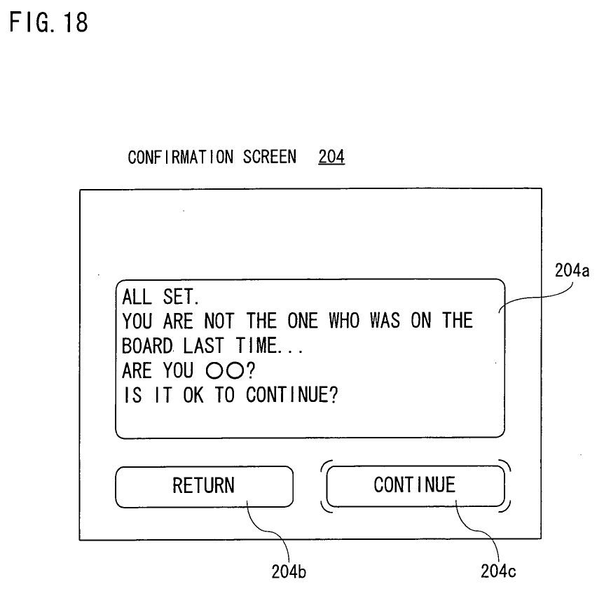

In this step, as shown in FIG. 18, the CPU 40 displays on the monitor 34 a confirmation screen 204 asking whether the current player is that player, and it is determined whether “CONTINUE” or “RETURN” is selected on the confirmation screen 204. As shown in FIG. 18, in the confirmation screen 204, a message display area 204a is provided and therebelow a button image 204b and a button image 204c are displayed. In the message display area 204a, a message is displayed that tells the player that a weight value has been detected and the detected weight value does not match a set reference value, that confirms (asks) whether the current player is a registered player (that player), and that asks whether to continue game play.

If “YES” in the step S65, i.e., if the button 204c is turned on, then it is determined that the current player is that player and thus in a step S67, the reference value stored in the memory is rewritten with the weight value of that player and then the process proceeds to the step S23. Note that the reference value may be rewritten with the detected load value instead of the weight value of that player. On the other hand, if “NO” in the step S65, i.e., if the button 204b is turned on, then it is determined that the current player is not that player and thus the process proceeds to a step S69.

In the step S69, it is pointed out that a different player is on the load controller 36. In this step, the confirmation screen 202 shown in FIG. 11(B) is displayed on the monitor 34 and in the confirmation screen 202 it is pointed out that the current player is one who is not registered in the memory and a player different from the immediate last player is on the load controller 36. In a subsequent step S71, it is determined whether to continue the game. If “NO” in the step S71, then the process directly returns to the step S3 shown in FIG. 13. On the other hand, if “YES” in the step S71, then in a step S73, the reference value stored in the memory is rewritten with the detected load value and then the process proceeds to the step S23.

Note that since in the third embodiment weight values of players are registered, when a game is started, a player may be selected and a weight value registered in association with the selected player may be set as a reference value.

In the third embodiment too, a player change is detected and a proper weight value is set as a reference value, and thus, proper game processing can be performed.

Note that although diagrammatic representation and a detailed description are omitted, the third embodiment can also be applied to the second embodiment. In such a case, instead of the steps S45, S47, and S49 in the flowchart shown in FIG. 15, the flowchart shown in FIG. 17 is performed.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A storage medium storing a load detection program to be executed by a computer of a load detection apparatus that includes a supporting board on which feet of a user can be put, said load detection program causing said computer to perform:
an instruction step of instructing to put the feet of said user on said supporting board;
a load value detection step of detecting a load value imposed on said supporting board;
a reference value setting step of setting the load value detected in said load value detection step, as a reference value of a weight value of said user;
an information processing step of performing information processing based on the reference value set in said reference value setting step and a load value to be detected in said load value detection step;
a judgment timing determination step of determining whether or not it is timing at which said reference value is to be judged;
a comparison step of comparing, when it is determined in said judgment timing determination step that it is timing at which said reference value is to be judged, the reference value set in said reference value setting step with the load value detected in said load value detection step; and
a reference value update step of resetting, when a comparison result obtained in said comparison step shows a mismatch, the load value detected in said load value detection step as said reference value.

2. A storage medium storing a load detection program according to claim 1, wherein in said comparison step, a difference between the reference value set in said reference value setting step and a load value to be detected in said load value detection step is detected and when the difference exceeds a predetermined value, a comparison result shows a mismatch.

3. A storage medium storing a load detection program according to claim 1, wherein
said load detection program further causes said computer to perform an instruction determination step of determining whether or not there is an instruction from said user to perform said information processing, and
in said judgment timing determination step, when it is determined in said instruction determination step that there is an instruction to perform said information processing, it is determined that it is judgment timing of said reference value.

4. A storage medium storing a load detection program according to claim 1, wherein
said load detection program further causes said computer to perform a load value determination step of determining whether or not, during performance of said information processing, a period of time during which a load value to be detected in said load value detection step is less than or equal to a predetermined value is maintained over a certain period of time, and
in said judgment timing determination step, when it is determined in said load value determination step that a period of time during which said load value is less than or equal to the predetermined value is maintained over a certain period of time, it is determined that it is timing at which said reference value is to be judged.

5. A load detection apparatus including a supporting board on which feet of a user can be put, said apparatus comprising:
an instruction means for instructing to put the feet of said user on said supporting board;
a load value detection means for detecting a load value imposed on said supporting board;
a reference value setting means for setting the load value detected by said load value detection apparatus, as a reference value of a weight value of said user;
an information processing means for performing information processing based on the reference value set by said reference value setting means and a load value to be detected by said load value detection means;
a judgment timing determination means for determining whether or not it is timing at which said reference value is to be judged;
a comparison means for comparing, when it is determined by said judgment timing determination means that it is timing at which said reference value is to be judged, the reference value set by said reference value setting means with the load value detected by said load value detection means; and
a reference value update means for resetting, when a comparison result obtained by said comparison means shows a mismatch, the load value detected by said load value detection means as said reference value.

6. A load detection method for a load detection apparatus including a supporting board on which feet of a user can be put, said method comprising the steps of:
(a) instructing to put the feet of said user on said supporting board;
(b) detecting a load value imposed on said supporting board;
(c) setting the load value detected in said step (b) as a reference value of a weight value of said user;
(d) performing information processing based on the reference value set in said step (c) and a load value to be detected in said step (b);
(e) determining whether or not it is timing at which said reference value is to be judged;
(f) comparing, when it is determined in said step (e) that it is timing at which said reference value is to be judged, the reference value set in said step (c) with the load value detected in said step (b); and
(g) resetting, when a comparison result obtained in said step (f) shows a mismatch, the load value detected in said step (b) as said reference value.
